(19) United States
(12) Patent Application Publication
(10) Pub. No.: US 2008/0043269 A1
(43) Pub. Date: Feb. 21, 2008

(54) Method and apparatus for processing image containing picture and characters

(75) Inventor: Yen-Cheng Chen, Hsinchu (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/889,951

(22) Filed: Aug. 17, 2007

(30) Foreign Application Priority Data
Aug. 21, 2006 (TW) 95130713

(51) Int. Cl. G06F 15/00; G06K 9/46; H04N 1/40

(52) U.S. Cl. 358/1.9; 358/1.11; 358/302; 358/462; 358/483; 382/190

(57) ABSTRACT

A method for processing an image containing a picture and character is provided. First, an image containing a picture and a plurality of characters is received. Afterwards, the picture is separated from the characters to respectively produce an image of the picture and at least one character block. Next, the characters of the at least one character block are recognized. Then, the character data corresponding to the characters of the at least one character block are produced.

This application claims the benefit of Taiwan application Serial No. 95130713, filed Aug. 21, 2006, the subject matter of which is incorporated herein by reference.

### BACKGROUND OF THE INVENTION

1. Field of the Invention

The invention relates in general to a method and apparatus for processing an image containing picture and characters, and more particularly to a method and apparatus for processing an image containing picture and characters and capable of editing characters and picture separately.

2. Description of the Related Art

Along with the improvement in optical resolution of scanners and printers and the advance in image processing methods, consumers' expectations of image quality also increase. Particularly, consumers expect no distortion occurs in outputs when a document containing both pictures and characters is scanned or printed.

However, when scanning or printing a document containing both pictures and characters, the scanners and the printers treat such document as an image, resulting in scanning and printing defects. For example, if the document is processed in a low-resolution text mode (such as black/white mode), the produced picture is either black or white, resulting in picture distortion. The character portion is often blurred and becomes hard to be recognized.

To the contrary, if the document is scanned or printed in a high-resolution photo mode (such as 8-bit grey level mode), the scanned or printed document has to be stored in an image format, a large memory space is occupied, the processing speed gets slower and processing time gets longer.

### SUMMARY OF THE INVENTION

The invention is directed to a method and apparatus for processing an image containing pictures and characters. The picture portion and the character portion of the image containing pictures and characters are separately processed, and the character portion is recognized as a pure text file. The character portion is distinct and does not occupy too much data storage space, and the picture portion is processed at a higher resolution level. Last, the character portion and the picture portion are merged to produce a document having distinct character and fascinating picture.

According to a first aspect of the present invention, a method for processing an image containing a picture and characters is provided. First, an image containing a picture and a plurality characters is received. Afterwards, the picture is separated from the characters to respectively produce an image of the picture and at least one character block. Next, the characters of the at least one character block are recognized. Then, the character data corresponding to the characters of the at least one character block is produced.

According to a second aspect of the present invention, an apparatus is provided. The image processing apparatus comprises a memory unit and an image processing unit. The memory unit stores character feature data, and the image processing unit is coupled to the memory unit. The image processing unit receives an image containing a picture and a plurality of characters and processes the image. The image processing unit separates the picture from the characters to respectively produce an image of the picture and at least one character block, recognizes the characters of the at least one character block, and produces character data with reference to the characters of the at least one character block and the character feature data.

The invention will become apparent from the following detailed description of the preferred but non-limiting embodiments. The following description is made with reference to the accompanying drawings.

### BRIEF DESCRIPTION OF THE DRAWINGS

FIG. 1 is a functional block diagram of an apparatus for processing an image containing a picture and characters of the invention;

FIG. 2 is a flowchart of a method for processing an image containing a picture and characters of the invention.

### DETAILED DESCRIPTION OF THE INVENTION

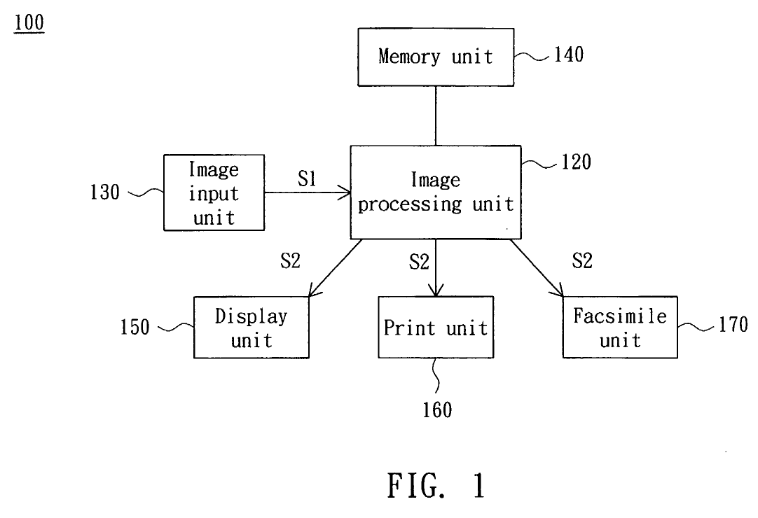

Referring to FIG. 1, a functional block diagram of an apparatus for processing an image containing a picture and characters of the invention is shown. The image processing apparatus 100 comprises an image processing unit 120, a display unit 150, a print unit 160, a memory unit 140 and a facsimile unit 170. The memory unit 140 stores character feature data. The image processing unit 120 is coupled with the memory unit 140. The image processing unit 120 receives and recognizes an image S1 containing a picture and a plurality of characters (not illustrated) and processes the image S1. The image processing unit 120 separates the picture from the characters to respectively produce an image of the picture and at least one character block. For example, the image processing unit 120 converts the image S1 into an image of the picture and a plurality of character blocks according to the technology for separating pictures and characters.

Besides, the memory unit 140 can also be used for storing the picture and the character block. The memory unit 140 further stores at least one of a location parameter and a size parameter for each character block relative to the image of the picture, such that subsequent steps of merging the picture and the characters and recognizing the character size are performed according thereto. Preferably, the image processing unit 120 further produces character attribute data comprising at least one of the character size parameters and the character font parameters of the recognized characters.

Preferably, the image processing unit 120 compares the character block with the image of the picture to produce at least one location parameter and a size parameter, relative to the image of the picture, for the character block. Afterwards, the location parameter and the size parameter are stored in the memory unit 140. The subsequent steps of merging the picture and the characters and recognizing the character attributes are performed according to the abovementioned parameters. The image processing unit 120 recognizes the characters of the character block to produce character data. For example, the image processing unit 120 discriminates the geometric features of the characters of character block using the optical character recognition (OCR) technology, that is, the image processing unit 120 compares the geometric features of the characters with a set of character feature data stored in the memory unit 140. Preferably, the image processing unit 120 further compares the character attribute data with the character feature data to produce the character data.

Any one who is skilled in the technology of the invention will understand that the technology of the invention is not limited thereto. For example, the image processing apparatus 100 further comprises an image input unit 130 coupled to the image processing unit 120 to generate the image containing the picture and characters. The image input unit 130 can be a charge coupled device (CCD) or a complementary metal oxide semiconductor (CMOS) photosensing element, or any other image sensor.

The image processing unit 120 further merges the image of the picture and the character data to produce and output a image file S2 containing the picture and the characters. The image processing apparatus 120 is coupled with the display unit 150, the printing unit 160, the memory unit 140 and the facsimile unit 170 to respectively display, print and store the image file S2, or alternatively send the image file S2 through telecommunication networks

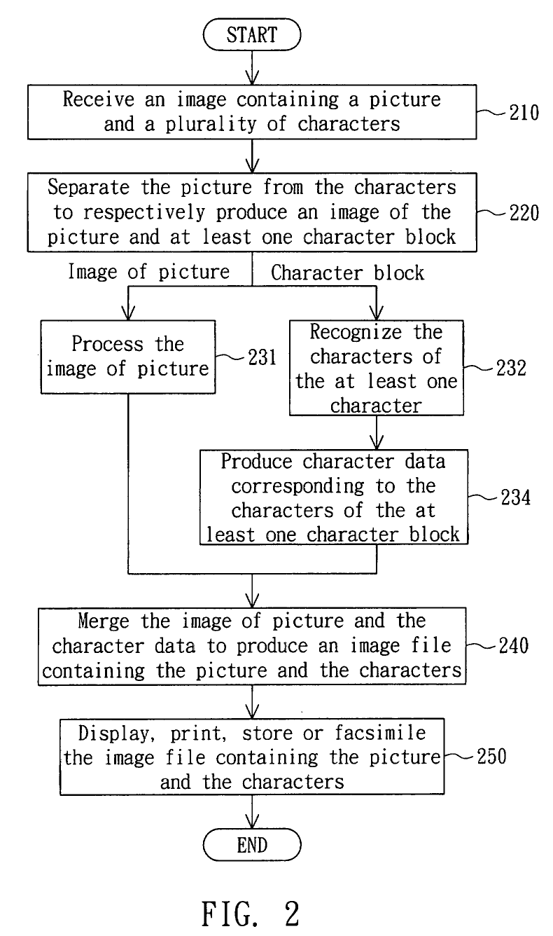

Referring to FIG. 2, a flowchart of an image processing method of the invention is shown. Also referring to FIG. 1, first, as indicated in step 210, the image processing unit 120 receives the image SI containing a picture and a plurality of characters from the image input unit 130. Next, as indicated in step 220, the image processing unit separates the picture from the characters to respectively produce an image of the picture and at least one character block. Next, the procedure is divided into two portions. In the image of picture processing portion as indicated in step 231, various ways of processing image such as color calibration, contrast calibration and brightness calibration are applied for improving picture quality. In the character blocks processing portion as indicated in step 232, the image processing unit 120 recognizes the character of the character block. Then, as indicated in step 234, character data corresponding to the characters of the character block are produced. Then, as indicated in step 240, the image of the picture and the character data are merged to produce an image file S2 containing the picture and the characters. The image file S2 can be further edited by other software. For example, the font type, the font size, and the color of the fonts can be changed and the picture can be enlarged or reduced. Next, as indicated in step 250, the image file S2 can use the display unit 150, the printing unit 160, the memory unit 140 and the facsimile unit 170 to display, print, store or facsimile the image file S2 respectively.

Any one who is skilled in the technology of the invention will understand that the technology of the invention is not limited thereto. For example, the image processing method can further comprising comparing the character block with the image of the picture to produce at least one of a location parameter and a size parameter, which are relative to the image of the picture, for the character block. Furthermore, the at least one of the location parameter and the size parameter for the character block can be stored in the memory unit 140.

Besides, step 232 further comprises producing character attribute data corresponding to the characters of each character block. The character attribute data comprise at least one of a character size parameter and a character font parameter. The character size parameter is generated by comparing the sizes of the characters of the character block with the character feature data stored in the memory unit 140. The character font parameter is generated by comparing the features of the characters of the character block with the character feature data. The character feature data could be data such as the fonts for text processing software, like WORD. Examples of the font type of the character include “Times New Roman” or “Arial”. The font size is designated by various font numbers such as NO. 14 or NO. 16. Examples of the character data could be text files with or without character attributes. Applicable files including character attributes could be WORD files of the Microsoft Corporation, or portable document files (PDF) of the Adobe Corporation. Preferably, step 232 further comprising providing character feature data and comparing the character attribute data with the character feature data to produce the character data. Furthermore, the picture processing portion can omit step 231. The picture could be merged with the character data without being processed in advance to produce image file S2. The advantage of the present invention is that the picture and the characters of the image file S2 can be edited separately.

Preferably, in step 240, the image of the picture and the character data are merged according to at least one of the location parameter, the character size parameter, and the character font parameter corresponding to the characters. Thus the relative location between the picture and the characters as well as the font types of the characters of the image file S2 are shown as the image S1. The user can use software to process either the picture or characters of the image file.

According to the method and apparatus for processing an image containing a picture and characters disclosed in the above embodiments of the invention, the recognition of the inputted picture portion and character portion are processed separately, and the character portion is recognized as a text file. Thus, the character portion remains distinct and occupies less data storage space. The picture portion is processed at a high resolution mode. Color, contrast and brightness can be calibrated separately. Afterwards, the character portion and the picture portion are merged to produce an image file containing the picture and the characters. Compared with a conventional scanner which scans in a text mode, the embodiment of present invention can show more details of the picture, and the picture is further distinguished from the characters. Compared with the conventional scanner which scans in a photo mode, the embodiment of present invention has a faster processing speed, and spends shorter processing time. Furthermore, the characters are stored in the data format of characters such as ASCII, not an image format stored in general Binary file. The embodiments of present invention largely reducing the data size of documents.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for processing an image containing a picture and characters, comprising:
receiving an image containing a picture and a plurality of characters;
separating the picture from the characters to respectively produce an image of the picture and at least one character block;
recognizing the characters of the at least one character block; and
producing character data corresponding to the characters of the at least one character block.

2. The image processing method according to claim 1, further comprising:
comparing the at least one character block with the image of the picture to produce at least one of a location parameter and a size parameter, relative to the image of the picture, for the at least one character block; and
storing at least one of the location parameter and the size parameter for the at least one character block.

3. The image processing method according to claim 2, further comprising:
merging the image of the picture and the character data according to at least one of the location parameter and the character size parameter for the at least one character block to produce an image file containing the picture and the characters.

4. The image processing method according to claim 1, where in the step of recognizing the characters of the at least one character block further comprises:
producing character attribute data corresponding to the characters of the at least one character block, wherein the character attribute data comprise at least one of a character size parameter and a character font parameter corresponding to each of the characters.

5. The image processing method according to claim 4, further comprising:
providing character feature data; and
comparing the character attribute data with the character feature data to produce the character data.

6. The image processing method according to claim 1, further comprising:
merging the image of the picture and the character data to produce an image file containing the picture and the characters.

7. The image processing method according to claim 6, further comprising:
displaying, printing, storing or facsimileing the image file containing the picture and the characters.

8. The image processing method according to claim 1, further comprises:
processing the image of the picture.

9. An image processing apparatus, comprising:
an image processing unit for receiving an image containing a picture and a plurality of characters and processing the image; and
a memory unit, coupled to the image processing unit, for storing character feature data;
wherein the image processing unit separates the picture from the characters to respectively produce an image of the picture and at least one character block, recognizes the characters of the at least one character block, and produce character data with reference to the characters of the at least one character block and the character feature data.

10. The image processing apparatus according to claim 9, further comprises an image input unit coupled to the image processing unit for generating the image.

11. The image processing apparatus according to claim 10, wherein the image input unit is one of a charge coupled device (CCD) and a complementary metal oxide semiconductor (CMOS) photosensing element.

12. The image processing apparatus according to claim 9, wherein the image processing unit further compares the at least one character block with the image of the picture to produce at least one location parameter and a size parameter, relative to the image of the picture, for the at least one character block, and the memory unit further stores at least one of the location parameter and the size parameter.

13. The image processing apparatus according to claim 9, wherein the image processing unit further produces character attribute data comprising at least one of a character size parameter and a character font parameter corresponding to each character.

14. The image processing apparatus according to claim 9, wherein the image processing unit further compares the character attribute data with the character feature data to produce the character data.

15. The image processing apparatus according to claim 9, wherein the image processing unit further merges the picture and the character data to produce an image file containing the picture and the characters.

16. The image processing apparatus according to claim 15, further comprising a display unit coupled to the image processing unit for displaying the image file containing the picture and the characters.

17. The image processing apparatus according to claim 15, further comprising a printing unit coupled to the image processing unit for printing the image file containing the picture and the characters.

18. The image processing apparatus according to claim 15, wherein the memory unit further stores the image file containing the picture and the characters.

19. The image processing apparatus according to claim 15, further comprising a facsimile unit coupled to the image processing unit for sending the image file containing the picture and the characters through telecommunication networks.
